(19) United States
(12) Patent Application Publication
(10) Pub. No.: US 2007/0147761 A1
(43) Pub. Date: Jun. 28, 2007

(54) Amorphous silicon waveguides on lll/V substrates with barrier layer

(76) Inventors: Martin H. Kwakernaak, New Brunswick, NJ (US); Winston Kong Chan, Princeton, NJ (US); Jongjin George Kim, East Windsor, NJ (US); Nagendranath Maley, Exton, PA (US); Leslie Herr, Exton, PA (US)

Correspondence Address: REED SMITH LLP, 2500 ONE LIBERTY PLACE, 1650 MARKET STREET, PHILADELPHIA, PA, 19103, US

(21) Appl. No.: 11/544,448

(22) Filed: Oct. 6, 2006

Related U.S. Application Data
(60) Provisional application No. 60/724,515, filed on Oct. 7, 2005.

(51) Int. Cl. G02B 6/10

(52) U.S. Cl. 385/131; 385/129

(57) ABSTRACT

An optical device and a method of forming the same is described. The optical waveguide includes a substrate, an etch-stop layer adjacent to the substrate, a barrier layer adjacent to the etch-stop layer, and an active waveguide having a lower cladding layer adjacent to the barrier layer. Also described is a method of coupling to at least one active waveguide. The method includes etching an active waveguide with a high selectivity towards a crystallographic plane to form a sloped terminice with respect to a substrate upon which the active waveguide is formed, and depositing at least one other waveguide over the etched sloped terminice and at least a portion of the substrate, wherein the at least one other waveguide is photonically coupled to the etched active waveguide to provide photonic interconnectivity for the etched active waveguide.

### CROSS REFERENCE TO RELATED APPLICATIONS

This Application claims the benefit of priority to copending U.S. Provisional Patent Application Ser. No. 60/724,515, entitled “AMORPHOUS SILICON WAVEGUIDES ON III/V SUBSTRATES WITH BARRIER LAYER”, filed Oct. 7, 2005, the entire disclosure of which is hereby incorporated by reference as if being set forth herein in its entirety.

### STATEMENT REGARDING FEDERALLY SPONSORED RESEARCH

N/A

### BACKGROUND OF THE INVENTION

1. Field of the Invention

The present invention is directed generally to waveguides, and, more particularly, to amorphous silicon waveguides on III/V substrates.

2. Description of the Background

Optical waveguides are the cornerstone of integrated optical circuits. An optical waveguide or combination of optical waveguides is typically assembled to form devices such as couplers, splitters, ring resonators, arrayed waveguide gratings, mode transformers, and the like. These devices are further combined on an optical chip to create an integrated optical device or circuit for performing the desired optical functions, such as, for example, switching, splitting, combining, multiplexing, demultiplexing, filtering, and clock distribution. As used herein, the expression “integrated optical circuits” may include a combination of optically transparent elongated structures for guiding, manipulating, or transforming optical signals that are formed on a common substrate or chip of monolithic or hybrid construction.

Typically, formation of the waveguide begins with formation of the lower optical cladding on a suitable substrate, followed by formation of an optical core, typically by chemical vapor deposition, lithographic patterning, and etching, and finally, surrounding the core with an upper optical cladding layer. For example, a ridge waveguide is typically formed on a substrate by forming a lower optical cladding, then forming through chemical vapor deposition, lithographic patterning, and etching, an optical core element, and lastly by surrounding the optical core element with an upper optical cladding layer. Other types of optical waveguides used in the formation of integrated optical devices and circuits include slab, ridge loaded, trench defined, and filled trench waveguides.

Further, semiconductor devices often include multiple layers of conductive, insulating, and semiconductive layers. Often, the desirable properties of such layers improve with the crystallinity of the layer. Attempts have been made to fabricate high quality crystalline optical waveguide devices. However, such attempts typically have succeeded only on bulk oxide substrates. Attempts to grow such devices on a single crystal semiconductor or compound semiconductors substrates, such as germanium, silicon, and various insulators, have generally been unsuccessful because crystal lattice mismatches between the host crystal of the substrate and the grown crystal of the optical waveguide layer have caused the resulting crystal of the optical waveguide layer to be of low crystalline quality.

Silicon (Si) is the most widely used semiconductor material in modern electronic devices. Single crystalline Si of high quality is readily available, and the processing and microfabrication of Si are well known. The transparency of Si in the near-infrared makes Si an ideal optical material.

In part due to these ideal optical properties, Si-based waveguides are often employed as optical interconnects on Si integrated circuits, or to distribute optical clock signals on an Si-based microprocessor. In these and other instances, Si provides improved integration with existing electronics and circuits. However, at present pure Si optical waveguide technology is not well developed, in part because fabrication of waveguides in Si requires a core with a higher refractive index than that of crystalline Si (c-Si).

Therefore, a need exists for a silicon based semiconductor structure that provides a high quality optical waveguide and for a process for making such a structure for the formation of quality optical waveguide devices.

### BRIEF SUMMARY OF THE INVENTION

An optical device is described herein. The optical device includes a substrate, an etch-stop layer adjacent to the substrate, a barrier layer adjacent to the etch-stop layer, and an active waveguide having a lower cladding layer adjacent to the barrier layer.

Also described is a method of forming the aforementioned optical device. The method includes forming an etch-stop layer over a substrate, forming a barrier layer over the etch-stop layer, forming a first cladding over the barrier layer, forming a core over the first cladding, and forming a second cladding over the core, wherein the first cladding, core and second cladding form an active waveguide.

Further described is a method of coupling to at least one active waveguide. The method includes etching an active waveguide with a high selectivity towards a crystallographic plane to form a sloped terminice with respect to a substrate upon which the active waveguide is formed, and depositing at least one other waveguide over the etched sloped terminice and at least a portion of the substrate, wherein the at least one other waveguide is photonically coupled to the etched active waveguide to provide photonic interconnectivity for the etched active waveguide.

Thus, the present invention provides a silicon based semiconductor structure for a high quality optical waveguide and subsequent devices.

### BRIEF DESCRIPTION OF THE SEVERAL VIEWS OF THE DRAWINGS

For the present invention to be clearly understood and readily practiced, the present invention will be described in conjunction with the following figures, wherein like reference numerals represent like elements, and wherein:

FIG. 1 is a block diagram of a layered optical waveguide;

FIG. 2 is a first Secondary Ion Mass Spectroscopy (SIMS) analysis of experimental data testing exemplary embodiments of the present invention;

FIG. 3 is a second SIMS analysis of experimental data testing exemplary embodiments of the present invention;

FIG. 4 is a photograph of showing blistering of amorphous silicon;

FIG. 5 is a schematic of layer structures at the junction area of waveguides; and

FIGS. 6 and 7 are flow diagrams of a modified formation protocol for optical waveguides according to an aspect of the present invention.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in typical waveguide architectures. Those of ordinary skill in the art will recognize that other elements are desirable and/or required in order to implement the present invention. However, because such elements are well known in the art, and because they do not facilitate a better understanding of the present invention, a discussion of such elements is not provided herein.

Amorphous silicon (a-Si) may present advantageous properties as silicon based waveguide core material. a-Si is understood to be a non-crystalline allotropic form of silicon. Silicon is normally tetrahedrally bonded to four neighboring silicon atoms, which is also the case in amorphous silicon. However, unlike crystalline silicon (“c-Si”), a-Si does not form a continuous crystalline lattice. As such, some atoms in an a-Si structure may have “dangling bonds,” which occur when one of the tetrahedral bonds of the a-Si does not bond to one of the four neighboring atoms. Thus, a-Si may be considered “under-coordinated.” The under-coordination of a-Si may be passivated by introducing hydrogen into the silicon. The introduction of hydrogen for passivation forms hydrogenated a-Si, which may provide a high electrical quality and relatively low optical absorption.

The density of pure silicon is lower than that of c-Si, and the refractive index of pure a-Si at near-infrared wavelengths may be higher than that of c-Si. Thus, in one exemplary embodiment of the present invention, a-Si may be serviceable as a waveguide core material on c-Si. However, as pure a-Si may contain a large density of point defects and dangling bonds, the optical absorption by an a-Si core at near-infrared wavelengths may be significant without the aforementioned hydrogen passivation. In other exemplary embodiments of the present invention, the upper cladding, core, and lower cladding may take the form of an a-Si based material, such as a-SiNxHy (0<x<1.3, 0<y<0.3), a-SiCxHy (0<x<1, 0<y<0.3), or a-SiOxHy (0<x<1, 0<y<0.3).

The refractive index of such an a-Si waveguide may be determined by selecting desirable core element and cladding refractive indices. If a higher refractive index contrast and appropriate waveguide geometry is chosen, very small bend radii may be possible for optical waveguides within integrated optical circuits without incurring significant propagation losses.

Hydrogenated a-Si films, such as those used in the aforementioned waveguides, may be deposited using a number of different techniques, including, for example, plasma enhanced chemical vapor deposition (PECVD), RF sputtering, and hot-filament CVD. Further, hydrogen content, void density, structural properties and optical and electronic properties of hydrogenated a-Si films may be critically dependent on the precise nature of the processing conditions by which the a-Si film is created. However, while hydrogenated a-Si may provide better transparency in the near-infrared than pure a-Si, pure a-Si may be processed more easily. Pure a-Si may also have a larger thermal stability then that of hydrogenated a-Si.

Further, such a-Si films may be formed using PECVD to have properties different from those of pure a-Si. For example, a N₂-based PECVD formation of a-Si may form an amorphous silicon nitride (a-SiN_{y}). Silicon nitrides may generally be used for a myriad of purposes in a variety of compound semi-conductor devices, such uses including, for example, surface passivation, interlayer elements and capacitor dielectrics.

As with any optics design, optical loss mechanisms, such as optical absorption and optical scattering losses, are of concern in the above-referenced waveguide embodiments. Scattering loss is common to all optical waveguide designs and is generally caused by roughness at the interfaces between core and clad, as well as by any inhomogeneities in the deposited film. Absorptive loss may be primarily dominated by optical absorption that excites stretching vibrational modes of atomic bonds between hydrogen or deuterium and heavier elements present in the deposited film. Such absorptive loss may depend heavily on the amount of hydrogen or deuterium in the film, and/or on the particular optical wavelength or wavelengths propagating in the waveguide.

Absorptive loss may particularly be an issue for optical wavelengths near the primary or lower order overtones of a hydrogen- or deuterium-related vibrational stretching mode. The strength of a stretching vibrational mode absorption feature may decrease significantly for higher overtones. As a result, most of the visible and near infrared spectrum in such instances may exhibit low optical absorptive loss. For optical wavelengths near absorption, the absorption strength may be minimized by, for example, reducing the amount of hydrogen in the film by selecting lower hydrogen content precursors, optimizing the deposition process, or by post-deposition annealing. By replacing hydrogen with deuterium, the energy of the set of related primary and overtone stretching vibrational modes may decrease.

While the process modifications immediately hereinabove allow for desirable levels for a-Si waveguides deposited on thermally oxidized silicon wafers, the depositing of a-Si layers on InP substrates may result in the above-referenced and additional issues. For example, a-Si waveguide losses may be substantially higher on InP substrates, and blistering of the a-Si film when the wafer is heated to above 300° C. may occur.

According to an aspect of the present invention, a method and apparatus may include a barrier layer of SiO₂ between a PECVD deposited amorphous silicon waveguide and a III/V substrate, such as an InP substrate. By inclusion of the SiO₂ barrier layer, inter-diffusion may be significantly eliminated, and may allow for the fabrication of low loss, high quality waveguides.

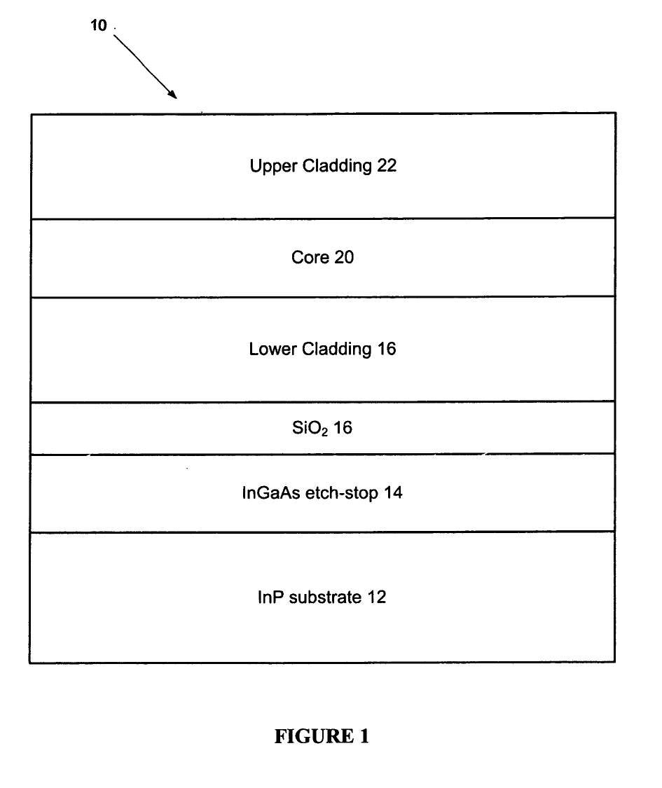

According to an aspect of the present invention, a waveguide 10, as illustrated in FIG. 1, may include a stack of quaternary layers upon a conventional InP substrate 12. The stack may form the active layer of the device and include an etch-stop layer 14, such as an InGaAs layer, or alternatively, alternating InGaAs and InGaAsP layers. The stack may further include a SiO₂ barrier layer 16 atop the etch-stop layer 14. Finally, atop SiO₂ barrier layer 16 may be a lower cladding layer 18, an active layer or core layer 20, and an upper cladding layer 22. In certain embodiments of the present invention, some of the layers, such as lower cladding layer 18, may be absent, provided the resulting waveguide maintains the desired functionality.

The various layers of waveguide 10 may have certain thicknesses in order to produce desired refractive indices. For example, the desired refractive index for upper cladding 22, core 20, and lower cladding 18 may be achieved by adjusting the composition of the a-Si based material forming the same. In an exemplary embodiment, upper and lower cladding layers 22 and 18 may have an index of refraction about 3.17, while core layer 20 may have an index of refraction between about 3.27 and 3.32. The upper and lower claddings may be of any suitable thickness, such as within ranges of about 0.25-0.3 μm for upper cladding 22, and about 1-1.5 μm for lower cladding 18, for example. Similarly, core layer 20 may be of any suitable thickness, such as within the range of about 0.3-1 μm. In a preferred embodiment, upper cladding layer 22 may be about 0.25 μm thick, core layer 20 about 0.8 μm thick, and lower cladding layer 18 about 1.5 μm thick. Substrate 12, such as an In-P substrate, may be about 0.35 mm thick, and may have an index of refraction of about 3.17, for example. As substrate 12 may be composed of a variety of materials other than InP, the thickness of substrate 12 will be dependent on the composition of such substrate material. Additionally, with regard to the stack of FIG. 1, SiO₂ barrier layer 16 may have a thickness in the range between 0.5 and 10 and 100 nm, and etch-stop layer 14 may have a thickness of approximately 0.4 μm.

In order to evaluate the effect of the type of semiconductor substrate on the optical loss of a waveguide formed thereon, several samples were fabricated with 0.25 μm a-Si top cladding (n=3.17), a 0.8 μm a-Si core (n=3.27), and different lower claddings, for use in a variety of experimental procedures. The thin upper cladding and wide core may allow for improved coupling of light into the planar waveguides, and simplification of measuring loss with a prism coupling system, such as a Metricon® coupling. The loss measurement results for this layer stack with different lower cladding thicknesses deposited on InP substrates are summarized in Table 1.

TABLE 1
Loss experiment summary for a-Si waveguides on inP substrates.

| Bottom clad | | Loss after 30 |
|---|---|---|
| thickness (d₃) | Loss | mins at 280° C. |
| 0.25 μm | 9-10 dB/cm | 10-11 dB/cm |
| 0.5 μm | 6-7 dB/cm | 8-10 dB/cm |
| 1.0 μm | 3-4 dB/cm | — |
| 1.5 μm | 3-4 dB/cm | 3-4 dB/cm |
| Control sample | 3-4 dB/cm | 3-4 dB/cm |
| (On SiO2/Si | | |
| substrate) | | |

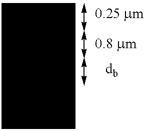

As shown in Table 1, waveguide loss may increase with decreasing lower cladding thickness. For example, when a bottom clad thickness of 0.25 μm was used, loss was 9-10 dB/cm. When a bottom clad thickness of 0.5 μm was used, loss was 6-7 dB/cm. For bottom clad thicknesses of 1.0 and 1.5 μm, loss was 3-4 dB/cm. Loss may also increase after heating the samples to approximately 280° C. for about 30 minutes. For example, upon heating loss was 10-11 dB/cm for a bottom clad thickness of 0.25 μm, and 8-10 dB/cm for a bottom clad of 0.5 μm. The loss appeared the same for bottom clad thicknesses of 1.0 and 1.5 μm after heating the samples to approximately 280° C. for about 30 minutes.

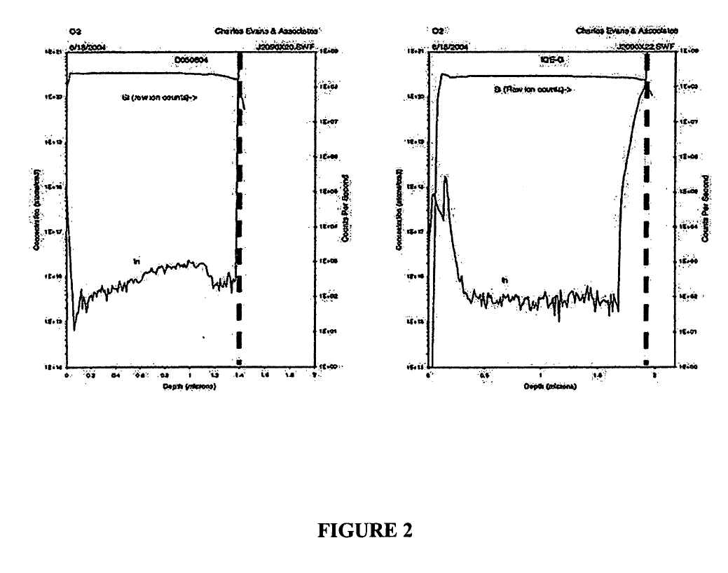

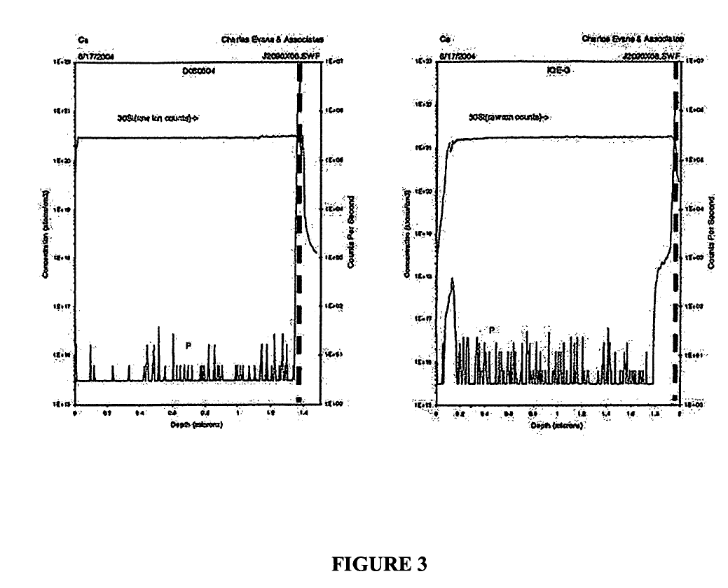

As seen in the data summarized in Table 1, the loss measurements suggest large optical losses near the a-Si/InP interface. Loss results of temperature treated samples suggest that that loss may increase, or the area of higher loss may expand, with heat treatment. Further, the Secondary Ion Mass Spectroscopy (SIMS) measurements of FIGS. 2 and 3 show diffusion of Indium and Phosphorous into the a-Si layers as a result of exposure to elevated temperatures.

FIGS. 2 and 3 show SIMS measurements of Indium and Phosphorus of two samples with a-Si films on top of InP substrates. The first sample (left) was measured directly after a-Si deposition. The second sample (right) was exposed to several heat cycles within the processing sequence of an integrated laser process. Diffusion of In and P occurred in the temperature treated sample.

As shown in FIG. 2, SIMS analysis of Indium was done on an unprocessed wafer (left) and on a processed wafer (right). The material in the area to the left of the dashed line is a-Si, while the material to the right of the dashed line is the InP substrate. As shown in FIG. 3, SIMS analysis of Phosphorus was done on an unprocessed wafer (left) and on a processed wafer (right). The material in the area to the left of the dashed line is again a-Si, and again to the right of the dashed line is the InP substrate.

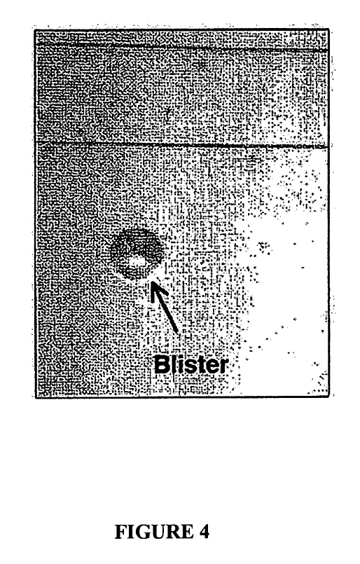

In addition to loss issues, a-Si films deposited onto InP substrates may develop blisters when the samples are heated during wafer processing. For example, device wafers are heated to above 300° C. during the annealing of metal contacts. Such a blister in an a-Si film is illustrated in FIG. 4.

According to an aspect of the present invention, and referring again to FIG. 1, SiO₂ layer 16 between the a-Si film and the semiconductor substrate may be introduced. The purpose of this layer may be to suppress diffusion and other unwanted processes between materials. Since SiO₂ layer 16 may act as an optical barrier, a rather thick lower cladding 18 may be needed to avoid distortions of the mode. Fabricating the integrated device with a thicker lower cladding may be facilitated if an etch-stop is used. In one embodiment, InGaAS etch-stop layer 14 is used, which also may act as an absorber for unguided light.

In a second set of experiments, losses were measured for waveguides with different SiO₂ layer thicknesses, and the results are summarized in Table 2. An approximately 80 nm SiO₂ layer with a 1.5 μm lower cladding may bring the loss to values obtained with a-Si waveguides on thermally oxidized Silicon substrates. Development of blisters is no longer observed with an SiO₂ layer between the a-Si film and the III/V semiconductor.

TABLE 2
Loss experiment summary for a-Si waveguides with different SiO2
barriers on InGaAsAnP substrates.

| Bottom | | | Loss after |
|---|---|---|---|
| clad | SiO2 | | 30 mins at |
| thickness | barrie | Loss | 280° C. |
| 1.5 μtm | 0 μm | 10.6-12.6 | |
| | | dB/cm | |
| 1.5 μm | 10 μm | 7.9-9.8 dB/cm | |
| 1.5 μm | 80 μm | 3.2-6.2 dB/cm | 5-5.2 |

| | | |
|---|---|---|
| Control sample | 4-5 dB/cm | 4-5 dB/cm |
| (On SiO2/Si | | |
| substrate) | | |

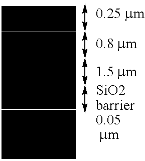

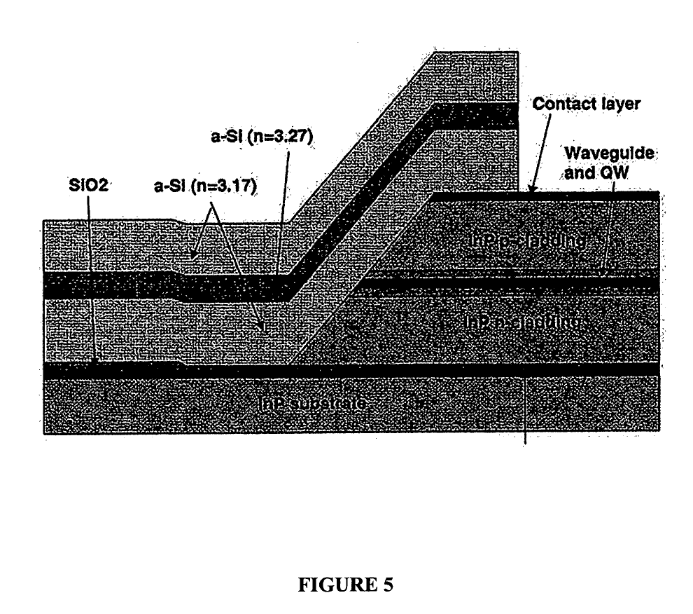

While introducing the SiO₂ layer may solve the issues with enhanced loss and blistering on InP substrates, the junction in the integrated device being formed may be modified by the presence of the SiO₂ layer, which may lead to undesired device behaviors. Because the refractive index of SiO₂ is much lower than that of the amorphous silicon and III/V materials, the SiO₂ may be removed from the optical path to avoid reflections and extra loss. In FIG. 5, an embodiment including a redesigned junction area is illustrated. The InGaAs etch stop absorption layer depicted in FIG. 5 is a thin SiO₂ layer introduced to prevent diffusion related loss in the ends of the a-SI waveguides just before the junction area.

Interfaces between active and passive components may have sloped regions. Referring now also to FIG. 5, there is shown a sloped active/passive junction or interface. Sloped coupling joints may reduce residual interface reflection in a-Si waveguide-based photonic integrated circuits, which may improve device performance. Such a design is superior to a vertical junction, as a vertical junction may tend to produce more significant back reflections for a given effective index mismatch between the active and passive waveguides. This back reflection may result in significant interference and losses, which can deteriorate the performance of optical devices. This risk may be at least partially mitigated by suppressing reflections using the sloped active-passive junction, since the average change of index may be less in such a structure and the back reflection is not directed at the waveguide.

According to an aspect of the present invention, a wet-based chemical etching method may be used to produce active-passive junctions with a high uniformity and reproducibility of slope angle and total etch depth. According to an aspect of the present invention, junction position and shape may be defined using conventional photolithographic techniques. In such a case, protective layers may take the form of a photoresist mask for use in further processing, for example. In general, and by way of non-limiting example only, several methods for forming a sloped coupling joint were presented in U.S. Patent Application Publication No. 2005/0117844, which is incorporated by reference herein.

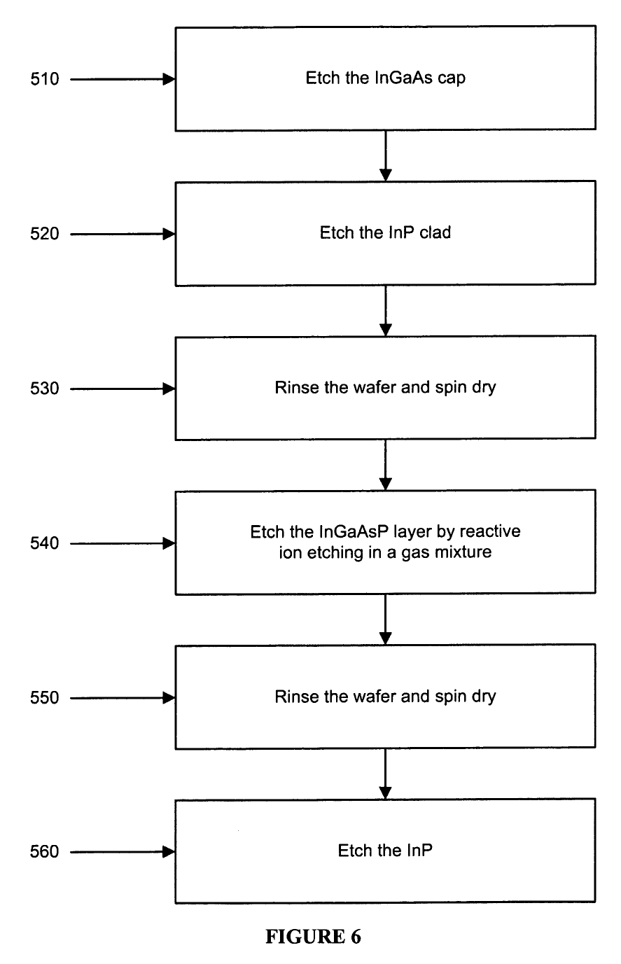

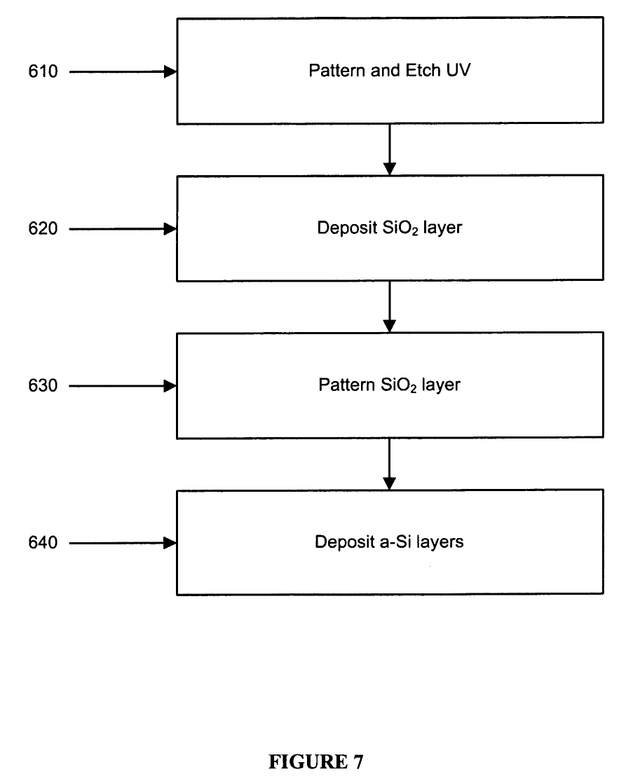

Referring now to FIGS. 6 and 7, the SiO₂ layer formation of the present invention may include modifications of the typical fabrication sequence described in U.S. Patent Application Publication No. 2005/0117844. At step 610, a UV pattern and etch may be performed. At step 620, an approximately 80-90 nm thick SiO₂ layer may be deposited. At step 630, the SiO₂ layer may be patterned. At step 640, the a-Si layers may be deposited. The deposition of the a-Si film over the patterned SiO₂ layer of thickness approximately 84 nm thick may make negligible the distortion of the mode resulting from the step in the a-Si.

In further embodiments, other barrier layers, such as Si₃N₄, may alternatively be used. The barrier layer may also be operable for a-Si depositions on InP substrates, InGaAsP layers on InP substrates, InAlAs on In substrates, or for a InGaAs layer on InP substrates, for example. The method described above may also be applied for use with other III/V substrates, such as GaAs, and other substrate as may be apparent to those skilled in the art.

Those of ordinary skill in the art will recognize that many modifications and variations of the present invention may be implemented. The foregoing description and the following claims are intended to cover all such modifications and variations falling within the scope of the following claims, and the equivalents thereof.

1. An optical device, comprising:
a substrate;
an etch-stop layer adjacent to said substrate;
a barrier layer adjacent to said etch-stop layer; and
an active waveguide having a lower cladding layer adjacent to said barrier layer.

2. The optical device of claim 1, wherein said substrate comprises a III/V substrate.

3. The optical device of claim 2, wherein said substrate comprises InP.

4. The optical device of claim 1, wherein said etch-stop layer comprises InGaAs.

5. The optical device of claim 1, wherein said barrier layer comprises SiO₂.

6. The optical device of claim 1, wherein said barrier layer has a thickness between approximately 0.08 μm and 0.1 μm.

7. The optical device of claim 1, wherein said active waveguide comprises the lower cladding layer, a core layer adjacent the lower cladding layer, and an upper cladding layer adjacent to the core layer.

8. The optical device of claim 7, wherein said upper and lower cladding layers comprise amorphous silicon.

9. The optical device of claim 7, wherein said core layer comprises amorphous silicon.

10. The optical device of claim 1, wherein said active waveguide comprises an optical waveguide.

11. The optical device of claim 10, wherein said optical waveguide forms part of at least one device selected from the group consisting of a laser, a light emitting diode, a super luminescent diode, a modulator, a gain section, and an amplifier.

12. The optical device of claim 1, wherein the index of refraction of said core layer is between approximately 3.27 and 3.32.

13. The optical device of claim 1, wherein the index of refraction of said upper and lower cladding layers is approximately 3.17.

14. A method of forming an optical device, comprising:
forming an etch-stop layer over a substrate;
forming a barrier layer over said etch-stop layer;
forming a first cladding over said barrier layer;
forming a core over said first cladding; and
forming a second cladding over said core, wherein said first cladding, core and second cladding form an active waveguide.

15. The method of claim 14, wherein said substrate comprises a III/V substrate.

16. The method of claim 15, wherein said substrate comprises InP.

17. The method of claim 14, wherein said etch-stop layer comprises InGaAs.

18. The method of claim 14, wherein said barrier layer comprises SiO₂.

19. The method of claim 14, wherein said lower cladding, core and upper cladding layers each comprise amorphous silicon.

20. The method of claim 14, wherein said forming of said lower cladding, core and upper cladding includes N₂-based PECVD formation.

21. A method of coupling to at least one active waveguide, comprising:
etching an active waveguide with a high selectivity towards a crystallographic plane to form a sloped terminice with respect to a substrate upon which the active waveguide is formed; and,
depositing at least one other waveguide over said etched sloped terminice and at least a portion of said substrate, wherein said at least one other waveguide is photonically coupled to said etched active waveguide to provide photonic interconnectivity for said etched active waveguide.

22. The method of claim 21, further comprising a barrier layer between said at least one other waveguide and said substrate.

23. The method of claims 21, wherein said barrier layer comprises SiO₂.
